(19) United States
(12) Patent Application Publication
(10) Pub. No.: US 2026/0260423 A1
(43) Pub. Date: Sep. 3, 2026

(54) ARTICULATED OBJECT MESH RECOVERY

(71) Applicant: Microsoft Technology Licensing, LLC, Redmond, WA (US)

(72) Inventors: Mohammad Sadegh ALI AKBARIAN, Cambridge (GB); Fatemehsadat Saleh, Cambridge (GB); Charles Thomas Hewitt, Cambridge (GB); Tadas Baltrusaitis, Cambridge (GB)

(21) Appl. No.: 19/066,861

(22) Filed: Feb. 28, 2025

(51) Int. Cl. G06T 17/20; G06T 7/73

(52) U.S. Cl. CPC G06T 17/20; G06T 7/73; G06T 2207/20021; G06T 2207/20084

(57) ABSTRACT

A method for recovering a three-dimensional mesh model of an articulated object from a two-dimensional image is disclosed. The method includes extracting features from the two-dimensional image by generating image patches and processing them through a vision transformer encoder to produce visual tokens and a classification (CLS) token. Landmarks are predicted by generating landmark heatmaps, determining initial landmark coordinates and confidence scores, and refining these coordinates using the CLS token. The method further involves estimating a three-dimensional pose of the articulated object through landmark-based feature pooling and processing the features through transformer decoder blocks to generate pose parameters. Finally, a three-dimensional mesh of the articulated object is generated using the pose parameters and a parametric model.

### TECHNICAL FIELD

Embodiments pertain to computer vision and machine learning. Some embodiments relate to methods and systems for detecting landmarks in two-dimensional (2D) images. Some embodiments relate to pose reconstruction. Further embodiments relate to combined landmark detection and pose reconstruction models for recovering three-dimensional mesh models of articulated objects from 2D images.

### BACKGROUND

Computer vision is a field of artificial intelligence and computer science that focuses on enabling machines to interpret and understand visual information from the world. It involves the development of algorithms and systems that can process, analyze, and interpret images and videos to extract meaningful information. These technologies are used in various industries such as healthcare for medical imaging, automotive for autonomous driving, security for surveillance, and entertainment for augmented reality and gaming.

For example, landmark detection is a computer vision technique that identifies specific key points on objects within two-dimensional images. These landmarks serve as reference points that help define an object's structure, features, and orientation. In object recognition and detection systems, landmarks help identify and classify objects by their characteristic points and features. Example uses of landmark detection include facial recognition (e.g., detecting facial landmarks in the eyes, nose, and mouth); medical imaging (e.g., aiding in identifying tumors or organs); biometric analysis; facial alignment; expression recognition; head pose estimation; and other applications.

Another example computer vision technique is pose reconstruction. Pose reconstruction determines the three-dimensional orientation and position of objects, particularly articulated objects with multiple joints. For articulated objects like hands, bodies, and faces, pose reconstruction calculates the relative positions and rotations of joints within a defined skeletal structure. This involves understanding how different parts of an articulated object relate to each other in three-dimensional space. Example applications include character animation; sports analysis, fitness and training applications for exercise form analysis and posture tracking; virtual shopping applications; animation and gaming (e.g., to create realistic character movements); surveillance and tracking; robotics training; augmented and virtual reality applications; medical applications, and the like.

Object mesh reconstruction is yet another computer vision process that generates complete three-dimensional surface representations of objects. For articulated objects, mesh reconstruction can utilize parametric models that define how the object's surface should deform based on underlying pose parameters. This allows for the creation of detailed geometric models that capture both the pose and shape characteristics of the object. Applications include character animation and gaming; 3D printing and manufacturing; virtual and augmented reality applications; and the like.

Both pose reconstruction and mesh reconstruction support various applications across industries. In computer gaming and animation, these technologies enable realistic character movement and rendering. For augmented and virtual reality applications, they allow for accurate representation and manipulation of virtual objects. In fields like medical imaging and motion analysis, these technologies provide valuable tools for understanding and visualizing complex three-dimensional structures and movements.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a feature extraction, landmark initialization, and refinement model according to some examples of the present disclosure.

FIG. 2 illustrates a pose estimation model according to some examples of the present disclosure.

FIG. 3 illustrates a combined landmark and pose prediction model according to some examples of the present disclosure.

FIG. 4 illustrates a model for predicting root orientation and translation according to some examples of the present disclosure.

FIG. 5 illustrates a flowchart of a method for reconstructing a mesh from a 2D image according to some examples of the present disclosure.

FIG. 6 illustrates components of a computing device that converts a 2D picture into 3D mesh coordinates according to some examples of the present disclosure.

FIG. 7 illustrates a block diagram of an example machine upon which any one or more of the techniques discussed herein may be performed according to some examples of the present disclosure.

### DETAILED DESCRIPTION

Prior art approaches to computer vision techniques suffer from various limitations. For example, landmark detection techniques utilize either direct regression of 2D coordinates or heatmap-based prediction methods. While direct regression could predict landmarks outside image bounds, it suffers from lower accuracy. Conversely, heatmap-based methods achieve better accuracy through image-to-image modeling but fail when landmarks fell outside the image.

As another example, pose reconstruction typically follows either parametric or non-parametric approaches. Parametric methods directly regressed pose parameters for articulated objects, while non-parametric approaches attempted to predict 3D meshes directly. This creates a tradeoff as non-parametric approaches offer higher accuracy but lack easy manipulation capabilities, while parametric approaches provide better control but are constrained in their ability to represent detailed deformations.

As yet another example, for mesh reconstruction, traditional methods rely on either direct vertex prediction or parameter regression. Direct vertex prediction achieves higher accuracy but makes subsequent modifications difficult. Parameter regression approaches operate in a more constrained space, making them easier to modify but less capable of representing fine details. Some recent approaches attempted to bridge this gap by predicting sparse 2D points, converting them to 3D, and then generating dense mesh vertices, though this multi-step process introduced additional complexity.

In addition, many existing solutions treat landmark detection, pose estimation, and mesh reconstruction as isolated problems. This separation failed to leverage the mutual information between these components, resulting in suboptimal results. High-quality landmark predictions are not effectively utilized to improve pose estimation, and pose parameters are not optimally incorporated into mesh generation. Additionally, the field lacked solutions that could simultaneously provide both high accuracy and easy manipulation capabilities, forcing applications to choose between precision and flexibility.

Disclosed in some examples are methods, systems, devices, and machine-readable mediums which solve the problems of landmark detection and pose reconstruction through two independent but combinable improvements. First, an improved landmark detection method addresses the limitations in landmark detection by combining heatmap-based and regression-based approaches. This hybrid solution enables accurate prediction of landmarks both within and outside image bounds through a Vision Transformer encoder for feature extraction, followed by a convolutional decoder for landmark heatmap generation and a specialized MLP for landmark refinement. Second, an improved pose reconstruction method may utilize landmark-based feature pooling to extract object-focused information that guides pose parameter estimation. The method first extracts features using either HR-Net or Vision Transformer, then uses landmark-based pooling to sample features at predicted landmark locations. This creates object-focused feature representations that explicitly represent areas of interest like joints and fingertips. These pooled features are then processed through a transformer-based pose decoder that combines per-landmark features (as context tokens) with globally averaged features (as query tokens) to estimate the pose parameters. This approach maintains the flexibility of parametric models while improving accuracy through better feature utilization.

These improvements may be implemented independently to enhance either landmark detection or pose reconstruction alone. When combined, they create an integrated solution where high-quality landmark predictions inform pose estimation through landmark-based feature pooling and transformer decoder blocks. The combined implementation enables information to flow effectively between stages while maintaining the ability to use each improvement separately based on application requirements.

While the described improvements may be utilized separately, in some examples, a single architecture may be utilized for both landmark and parameter estimation that allows a deep neural network (DNN) to exploit the mutual information of these tasks. With high quality landmark prediction leading to better pose estimation through landmark-based feature pooling, this delivers quality improvements to the model-fitting task and improves efficiency as a single architecture recovers all the necessary information for model fitting.

### Improved Landmark Detection

The improved landmark detection architecture utilizes image-space heatmaps for initial landmark prediction, followed by a refinement process that incorporates both the initial landmark coordinates and their confidence scores. For landmark prediction, the method can be broken into several phases: feature extraction, landmark initialization, and landmark refinement.

In the feature extraction phase, the system processes the input image to generate a set of features that describe the input image. This is achieved by dividing the image into non-overlapping patches (e.g., 16×16 pixels) and passing these patches through a Vision Transformer (ViT) encoder. In some examples a classification token (CLS) may also be passed through the ViT encoder. The ViT encoder processes the patches through multiple transformer encoder blocks, each consisting of self-attention layers, multi-layer perceptron (MLP) layers, and skip connections to generate refined visual tokens that contain rich information about the input image and a refined classification (CLS) token that encapsulates the global context of the image. Specifically, the refined visual tokens represent detailed information about each patch of the image whereas the refined CLS token contains global information about the entire image.

The landmark initialization phase involves predicting the initial coordinates of the landmarks using a heatmap-based approach. A convolutional decoder is applied to the refined visual tokens to generate a set of low-resolution heatmaps, each representing the likelihood distribution of a distinct landmark's position in the image.

Each channel of the generated heatmaps represents the Gaussian distribution of where the keypoint may be present in the input image. While the heatmaps cannot represent points of interest outside the image plane, they may indicate where potential landmarks may be. The coordinates with the maximum likelihood in each heatmap are identified as the initial landmark coordinates, and their corresponding confidence scores are also determined. If a keypoint falls outside the image it typically manifests with a low confidence all over the image. This signal may be used in later stages.

Following the initial landmark prediction, the landmark refinement phase aims to improve the accuracy of the landmark coordinates. This is done by utilizing the initial landmark coordinates and their confidence scores, along with the transformed CLS token from the VIT encoder. The initial coordinates and confidence scores are encoded using two shallow MLPs to encode information about initial coordinates and confidence scores separately, which allows a refiner MLP to learn to assign appropriate importance to initial guesses for landmarks with high initial confidence. The refiner MLP processes this information to produce refined landmark coordinates and updated confidence scores, ensuring higher accuracy in landmark prediction. In some examples, the system may use a Gaussian Negative Log-Likelihood (GNLL) loss function during training to encourage the model to predict landmark distributions that maximize the likelihood of the ground truth landmarks, along with a reconstruction loss on the heatmaps.

### Pose Estimation and Mesh Recovery

The improved pose estimation method begins with feature extraction and landmark prediction from the input image. In some examples the landmark prediction discussed above may be used. In other examples, other methods, such as an HR-Net may be used to extract feature maps which are then used as input to a regression-based landmark prediction model.

The estimated landmarks are used to pool landmark-specific features from the extracted feature map through a grid-sampling approach. This landmark-based pooling helps focus on features that explicitly represent the object of interest, such as joints and fingertips of a hand. This results in a per-landmark feature map that provides object-focused 2D evidence information.

Both the per-landmark tokens and the enhanced CLS token are transformed by transformation matrices to a shared latent space. The CLS token is converted to a query token, whereas the landmark tokens are transformed into context tokens.

These transformed tokens are then processed through multiple transformer decoder blocks and finally a pose decoder MLP. The query token represents global feature information that describes the entire image and can be specifically tuned for pose estimation, while the context tokens provide explicit landmark-specific information. This combination of global and local information helps the system generate more accurate pose parameters.

In an enhanced implementation, the system uses features from a Vision Transformer instead of HR-Net and employs a more expressive pose decoder. The context information represents features that explicitly describe the input image at landmark positions, while the query represents global feature representation describing the entire image. These are transformed to share a common latent space through transformation matrices before being processed through multiple transformer decoder blocks. The final MLP generates a canonical pose where the root joint's orientation is forward-facing and positioned at the coordinate system's center.

For mesh recovery, the system utilizes a parametric model of the articulated object. The canonical pose parameters are used with the parametric model to compute a canonical mesh. Using the fixed topology of the mesh and the same landmark definition used for 2D landmarks, the system samples points on the mesh surface to represent 3D landmarks corresponding to the 2D landmarks. This information, combined with fixed camera assumptions, enables the use of a Perspective-n-Point (PnP) algorithm to optimize for the object's pose and translation, specifically determining the pose and translation of the root joint.

The complete model parameters, including pose, translation, and shape, can then be used to generate the final mesh. When implemented with model fitting, these parameters serve as initialization for a procedure that minimizes reprojection error to the predicted 2D landmarks. Testing on the FreiHAND benchmark dataset demonstrates significant improvements in accuracy compared to previous approaches.

The disclosed method may be trained end-to-end on synthetic data, with images containing the object of interest. The training process involves optimizing the model to predict landmark coordinates and their corresponding uncertainty estimates, using a loss function that encourages the model to maximize the likelihood of the ground truth landmarks. The model may be trained for multiple epochs, with a batch size and learning rate that ensure effective convergence.

The technical problem addressed by the invention is the challenge of accurately and robustly reconstructing the three-dimensional pose of articulated objects from two-dimensional images, particularly in scenarios where landmarks are occluded or fall outside the image boundaries. Existing methods often struggle to achieve both high accuracy and robustness, and they may require separate architectures for landmark and parameter estimation, leading to increased computational complexity and processing time. The technical solution provided by the invention combines the strengths of direct regression and heatmap-based approaches within a novel model architecture. This integrated approach utilizes image-space heatmaps for initial landmark prediction, followed by a refinement process that incorporates both the initial landmark coordinates and their confidence scores. Additionally, the invention employs landmark-based feature pooling to enhance the estimation of model parameters, allowing for high-quality pose estimation and efficient recovery of three-dimensional mesh models. This comprehensive solution ensures accurate landmark prediction, even for occluded or out-of-bounds landmarks, and reduces computational complexity by using a single architecture for both landmark and parameter estimation.

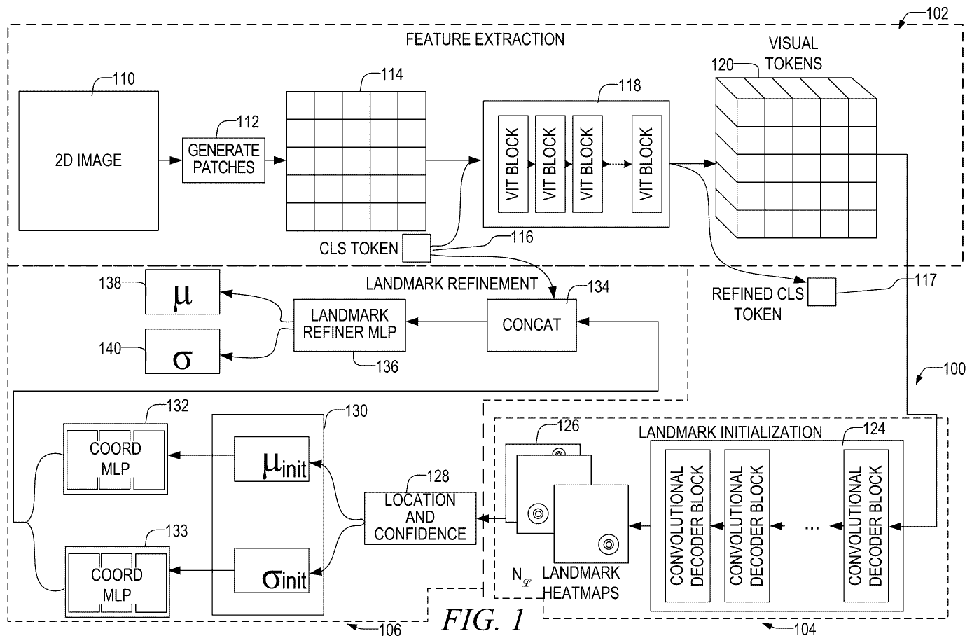

FIG. 1 shows a landmark detection system 100 with feature extraction, landmark initialization, and refinement stages according to some examples of the present disclosure. The process begins with feature extraction 102 where a 2D image 110 is divided into non-overlapping patches 114 by patch generation component 112. In some examples, the patches 114 may be 16×16 pixels in size. Additionally, a classification (CLS) token 116 is generated. The CLS token may be an additional parameter learned by the model and encompasses the global information about the entire image that best serves the task that the model is trained for. These patches and the CLS token 116 are then processed through a Vision Transformer (ViT) encoder 118, which may include multiple ViT blocks. The ViT encoder generates visual tokens 120 and a refined CLS token 117. The ViT encoder 118 includes multiple transformer encoder blocks, each comprising self-attention, MLP, and skip connections.

In the landmark initialization phase 104, the visual tokens 120 are fed into a convolutional decoder 124, with multiple convolutional decoder blocks. The convolutional decoder 124 generates Nₗ landmark heatmaps 126 where each channel of the heatmaps represents a Gaussian distribution of where the keypoint may be present in the input image. The location and confidence scores 128 are determined from the heatmaps, identifying the initial landmark coordinates μᵢₙᵢₜ and their corresponding confidence scores σᵢₙᵢₜ 130.

Next, the initial landmark coordinates and confidence scores are refined in the landmark refinement phase 106. The initial coordinates and confidence scores 130 are processed through shallow multi-layer perceptrons (MLPs) 132, 133, which encode the initial coordinates and their confidence scores. This encoded information is then concatenated in the concat layer 134 with the refined CLS token 117 and fed into the landmark refiner multi-layer perceptron (MLP) 136. The landmark refiner MLP 136 produces refined landmark coordinates u 138 and updated confidence scores σ 140, ensuring higher accuracy in landmark prediction.

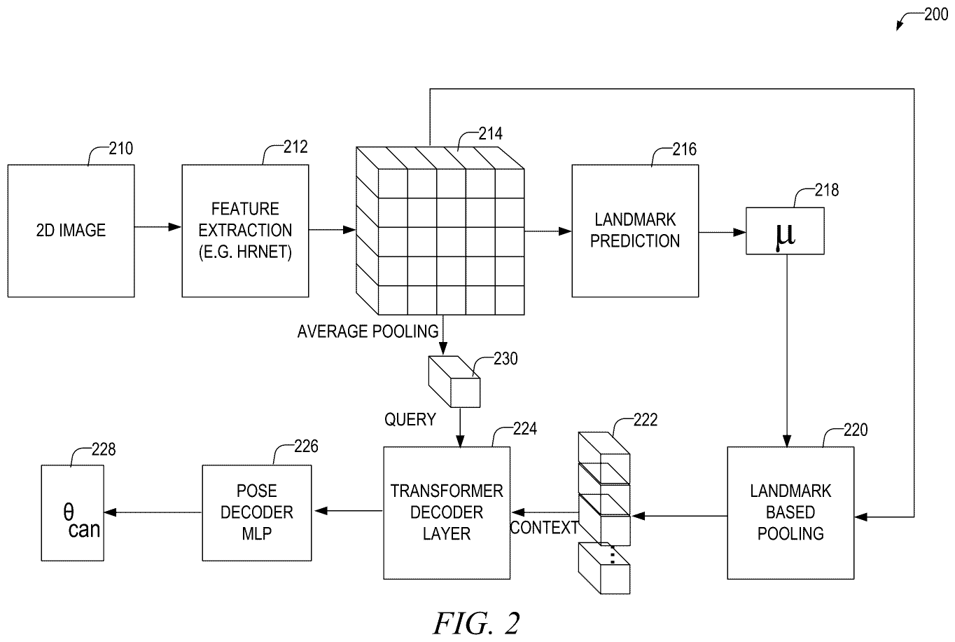

FIG. 2 illustrates a pose reconstruction model 200 for determining canonical pose parameters of an articulated object. The model 200 receives a two-dimensional input image 210 which is processed through a feature extraction component 212 (e.g., implemented using an HR-Net architecture, or the like) to generate feature tokens 214. The feature tokens 214 are provided to a landmark prediction component 216 which generates landmark coordinates 218. These landmark coordinates identify key points of the articulated object within the two-dimensional image.

A landmark-based pooling component 220 receives both the feature tokens 214 and landmark coordinates 218. The pooling component samples features at the predicted landmark locations to generate per-landmark tokens 222 that provide object-focused feature representations explicitly representing areas of interest like joints and fingertips. The per-landmark tokens 222 serve as context information that is provided to a transformer decoder layer 224. The transformer decoder layer 224 also receives a query 230 generated from globally averaged features. The transformer decoder processes both the local landmark-based context and global query information.

The output of the transformer decoder layer 224 is provided to a pose decoder MLP 226 which generates the canonical pose parameters 228. These parameters define a canonical pose where the root joint's orientation is forward-facing and positioned at the coordinate system's center.

The pose parameters 228 represent the rotations of joints relative to the root joint, with the root joint orientation fixed in a forward-facing position. The parameters specifically encode rotations for (J−1) joints in a 6D representation format.

### Combined Landmark and Pose Model

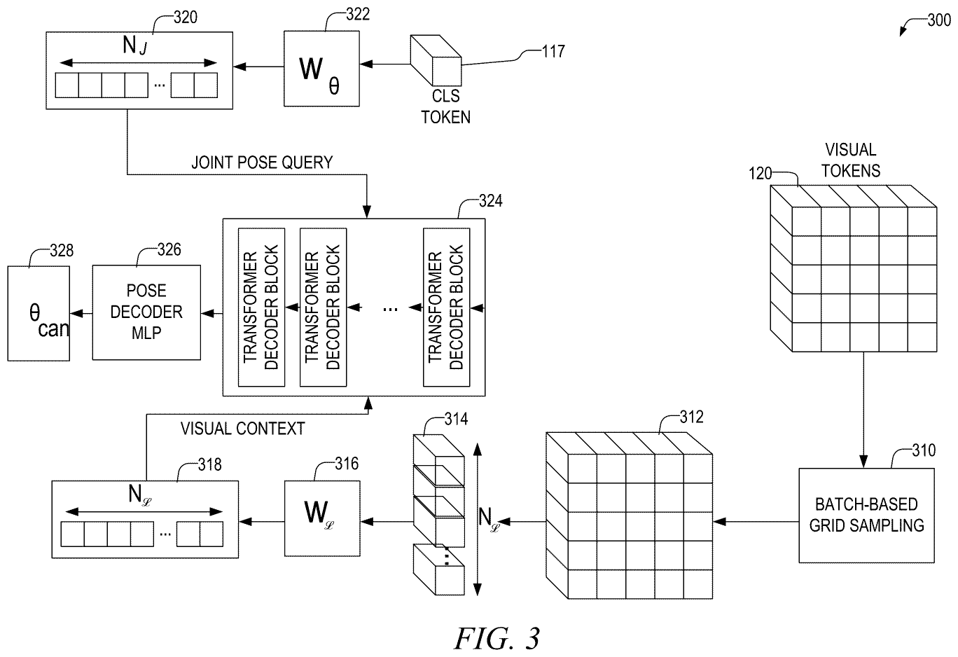

FIG. 3 illustrates a pose estimation model 300 that estimates a canonical pose θ using the output of the landmark estimation model 100 according to some examples of the present disclosure. The pose reconstruction utilizes two sources of information to estimate the pose: the context and the query. The context is represented by features that explicitly describe the input image in the landmark positions. The query is represented by the global feature representation that describes the entire image and can be tuned for specific task (here pose estimation). This information is then used in a transformer-based decoder model to recover the canonical pose.

The system begins with batch-based grid sampling 310, which processes the visual tokens 120 of the input image (generated from FIG. 1) to generate visual tokens with a landmark overlay 312. Landmark overlay 312 shows that with grid sampling 310, the features in the visual tokens correspond to the a landmark.

Per-landmark tokens 314 are then created from visual tokens with the landmark overlay 312. These per-landmark tokens represent specific features of the object of interest, such as joints and fingertips of a hand. The per-landmark tokens 314 are then transformed into a shared latent space (e.g., similar dimensions) with the joint pose query using matrix Wₗ 316 creating visual context 318, which encapsulates detailed information about the landmark positions.

The refined CLS token 117, which contains global context information from the input image, is processed using matrix We 322 to transform it into the shared latent space with the per-landmark tokens to generate a joint pose query 320. This query is used to provide a global context for the pose estimation process.

The visual context 318 and the joint pose query 320 are then fed into transformer decoder 324. The transformer decoder 324 may include a plurality of blocks. These blocks process the inputs through multiple layers to refine the pose estimation. The blocks of the transformer decoder 324 utilize the detailed landmark-specific information from the visual context 318 and the global context from the joint pose query 320 along with a pose decoder MLP 326 to generate canonical pose θ_{can}∈ [symbol] ^{(j-1)×6}. The canonical pose 328 is the pose where the root joint's orientation is forward facing and the root joint is placed at the center of the coordinate system. Since the root joint orientation is fixed, the model does not predict it-which is why the model predicts the rotation of (J−1) joints. Rotations are represented in 6 dimensions (6D).

3D Mesh Generation from Pose Parameters

A three-dimensional mesh of the articulated object may then be generated using the pose parameters and a parametric model. The model may generate a 3D mesh M as a function of the joint rotations θ, the shape parameters β, and the translation of the root joint t, denoted as M=f(θ,β, t). The joint rotations θ define the relative orientation of each joint with respect to its parent in the kinematic chain, and β accounts for variability in shape, such as different body sizes or proportions. Each joint is represented by a local rotation matrix or axis-angle rotation, applied relative to its parent joint in the hierarchy. The full pose of the object is defined by the combination of these local joint rotations, propagated through the kinematic chain to compute the final pose of the mesh.

In some examples, the combined model may be trained end-to-end on synthetic data. Since the model predicts landmark coordinates and their corresponding uncertainty estimates [μ,σ], a loss function may be provided that encourages the model to predict such distribution over landmarks that maximizes the likelihood of the ground truth (GT) landmarks. GT landmarks are the true 2D location of the landmarks provided in the training dataset. In some examples, a Gaussian Negative Log-Likelihood (GNLL) may be used, such as:

$${L}_{landmark} = {\sum }_{i = 1}^{{N}_{ℒ}} λ ( log ( {σ}_{i}^{2} ) + \frac{{‖ {μ}_{i} - {μ}_{i}^{′} ‖}^{2}}{2 {σ}_{i}^{2}} )$$

Where μᵢ′ is the GT location of landmark i. To supervise the landmark initialization, a reconstruction loss on the heatmaps may be added. Specifically:

$${L}_{landmark} = \frac{1}{{N}_{ℒ}} {\sum }_{i = 1}^{{N}_{ℒ}} {‖ {h}_{i} - {h}_{i}^{′} ‖}^{2}$$

Where hᵢ′ is the heatmap of landmark i. To encourage the model to learn correct canonical pose θ_{can} the following may be used:

$${L}_{can} = \frac{1}{{N}_{ℒ}} ( {\sum }_{i = 1}^{{N}_{J}} {‖ {θ}_{i} - {θ}_{i}^{′} ‖}^{2} + {‖ {P}_{i} - {P}_{i}^{′} ‖}^{2} + arccos ( \frac{tr ( {{R}_{i} ( {R}_{i}^{′} )}^{T} ) - 1}{2} ) )$$

Where in the first term, the L2 loss on the joint rotations is directly computed and in the second term, the L2 loss on the joint positions (derived from computing the forward kinematics on the rotations) is computed, and finally in the third term, the geodesic distance between the predicted and GT joint rotations (after applying forward kinematics) is computed.

In some examples, the model was trained on images of size 224×224 containing an object of interest. The model was trained on 600 epochs, with batch size of 128 using an AdamW optimizer with the initial learning rate of 1e⁻⁴, reducing by a factor of 0.5 every 100 epochs. One of ordinary skill in the art with the benefit of the present disclosure would appreciate this is exemplary only and other image sizes, epoch numbers, batch sizes, learning rates, and reduction factors may be used.

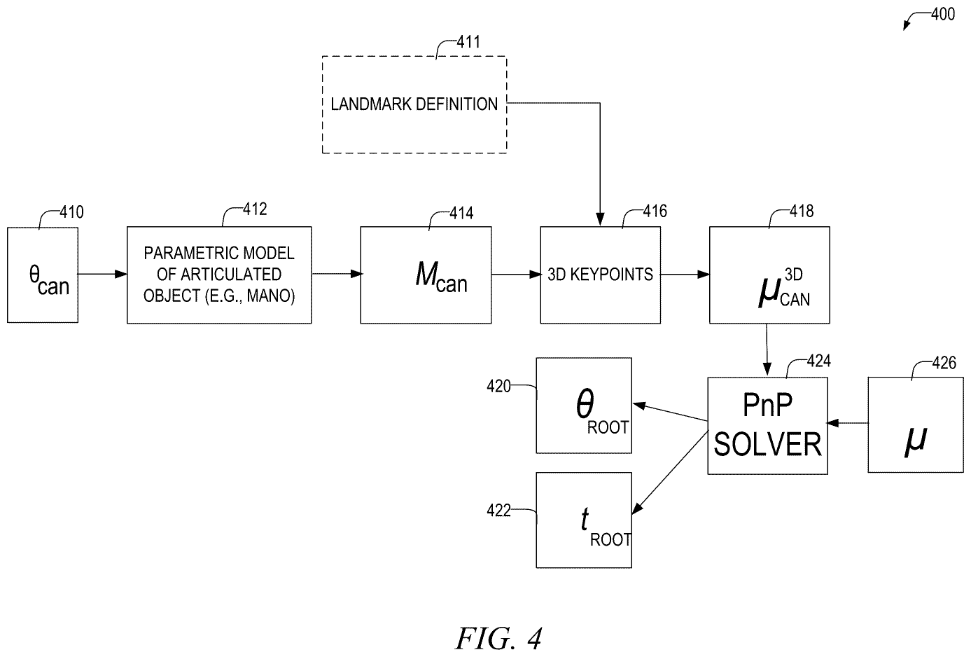

In the previous examples, the prediction of the pose was done in canonical space (e.g., fixed root orientation, positioned at the center of the coordinate system). In some examples, the model may predict root orientation and translation by solving the Perspective-n-Point algorithm (PnP). FIG. 4 illustrates a model for predicting root orientation and translation 400 according to some examples of the present disclosure. Given the canonical pose 410, the parametric model 412 is used to compute the canonical mesh M_{can} 414. One example such parametric model is hand Model with Articulated and Non-rigid defOrmations (MANO). Since the topology of the mesh is fixed and known, the same landmark definition used for landmarks 411 in the previous phases may be used to sample a subset of points on the surface of the mesh 416 that represent 3D landmarks,

$${μ}_{can}^{3 D} 418 ,$$

corresponding to the 2D landmarks. This set of information (along with a fixed camera assumption 426) is enough to use the PnP algorithm 424 and optimize for the object pose 420 and translation 422. The result is the pose and translation of the root joint of the object.

The complete model parameters (pose, translation and shape) can then be used to initialize a model fitting procedure in which the reprojection error is minimized to the predicted 2D landmarks. In experiments using the FreiHAND benchmark dataset the Procrustes aligned mean per-joint position error (PA-MPJPE) in mm is reduced from 8.6 to 7.8 mm for a DNN only and 8.6 to 7.5 mm using DNN+model fitting.

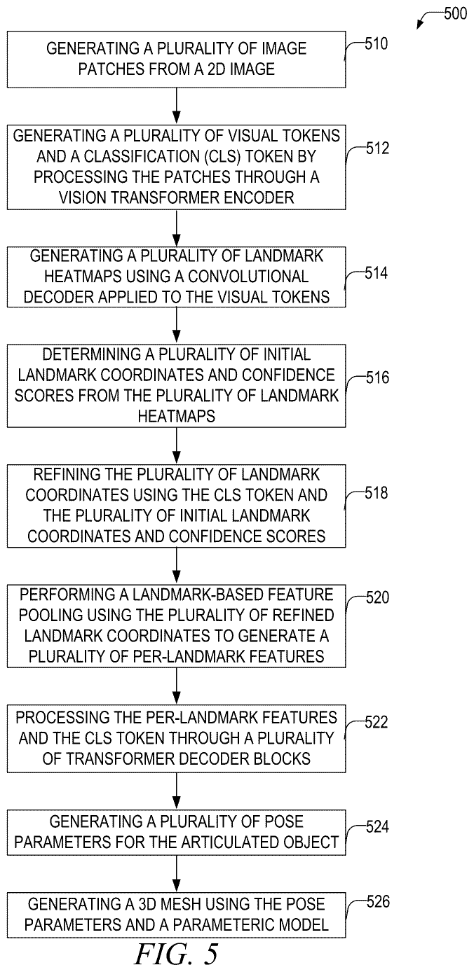

FIG. 5 shows a flowchart of a method 500 for reconstructing a mesh from a 2D image using the combined model according to some examples of the present disclosure. At operation 510, the method begins with generating a plurality of image patches from a 2D image. This step involves dividing the input 2D image into smaller, non-overlapping patches, which are then used for further processing. At operation 512, the method involves generating a plurality of visual tokens and a classification (CLS) token by processing the patches through a vision transformer encoder. The vision transformer encoder processes the image patches through multiple transformer encoder blocks, each consisting of self-attention layers, multi-layer perceptron (MLP) layers, and skip connections. This results in the generation of refined visual tokens and a CLS token that encapsulates the global context of the image.

At operation 514, a plurality of landmark heatmaps is generated using a convolutional decoder applied to the visual tokens. Each channel of the heatmaps represents the Gaussian distribution of where a keypoint may be present in the input image. These heatmaps serve as initial guesses for the landmark positions. At operation 516, the method involves determining a plurality of initial landmark coordinates and confidence scores from the plurality of landmark heatmaps. The coordinates with the maximum likelihood in each heatmap are identified as the initial landmark coordinates, and their corresponding confidence scores are also determined.

At operation 518, the plurality of landmark coordinates is refined using the CLS token and the plurality of initial landmark coordinates and confidence scores. This refinement process involves encoding the initial coordinates and confidence scores using shallow MLPs, which provide the necessary context for the landmark refiner MLP. The refiner MLP processes this information to produce refined landmark coordinates and updated confidence scores, ensuring higher accuracy in landmark prediction.

At operation 520, the method performs landmark-based feature pooling using the plurality of refined landmark coordinates to generate a plurality of per-landmark features. This step involves sampling features from the visual tokens at locations corresponding to the refined landmark coordinates, resulting in per-landmark feature maps that act as object-focused 2D evidence information. At operation 522, the per-landmark features and the CLS token are processed through a plurality of transformer decoder blocks. These blocks utilize the detailed landmark-specific information from the per-landmark features and the global context from the CLS token to refine the pose estimation.

At operation 524, the method generates a plurality of pose parameters for the articulated object. These pose parameters define the relative orientation of each joint with respect to the parent in the kinematic chain, accounting for the object's pose. At operation 526, the method involves generating a 3D mesh using the pose parameters and a parametric model. The parametric model, which defines the shape and structure of the articulated object, is used to create the 3D mesh based on the pose parameters. This mesh accurately represents the spatial configuration of the object in three-dimensional space. In some examples, the mesh may be used in augmented reality, virtual reality, games, and other applications. For example, the mesh may be displayed, e.g., as part of a graphical scene.

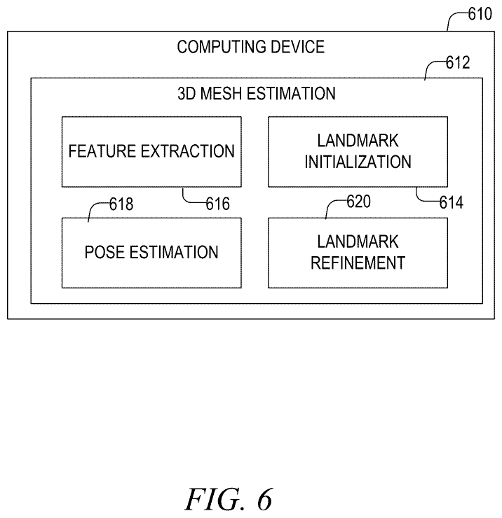

FIG. 6 shows a computing device 610 that converts a 2D picture into 3D mesh coordinates according to some examples of the present disclosure. The computing device 610 includes a 3D mesh estimation component 612, which is responsible for the overall process of converting 2D images into 3D mesh models. The 3D mesh estimation component 612 comprises several sub-components, each performing a specific function in the mesh recovery process. The feature extraction component 616 is responsible for extracting features from the input 2D image. This component processes the image to generate a set of features that describe the input image, which are crucial for subsequent stages of the mesh recovery process.

The landmark initialization component 614 predicts the initial coordinates of the landmarks using a heatmap-based approach. This component generates a set of low-resolution heatmaps, each representing the likelihood distribution of a distinct landmark's position in the image. The initial landmark coordinates and their corresponding confidence scores are determined from these heatmaps. The landmark refinement component 620 refines the initial landmark coordinates to improve their accuracy. This component utilizes the initial landmark coordinates and their confidence scores, along with additional information from the feature extraction component 616, to produce refined landmark coordinates and updated confidence scores.

The pose estimation component 618 estimates the three-dimensional pose of the articulated object using the refined landmark coordinates. This component performs landmark-based feature pooling to generate per-landmark features, which are then processed through transformer decoder blocks to generate the pose parameters for the articulated object. Together, these components enable the computing device 610 to accurately recover a three-dimensional mesh model of an articulated object from a two-dimensional image, leveraging the strengths of both direct regression and heatmap-based approaches within a novel model architecture.

While the disclosure herein described and used both a landmark prediction method and a 3D mesh recovery method together, one of ordinary skill in the art will appreciate that the landmark prediction method may be used without the 3D mesh recovery and similarly the 3D mesh recovery method may improve mesh recovery when used with other landmark prediction methods.

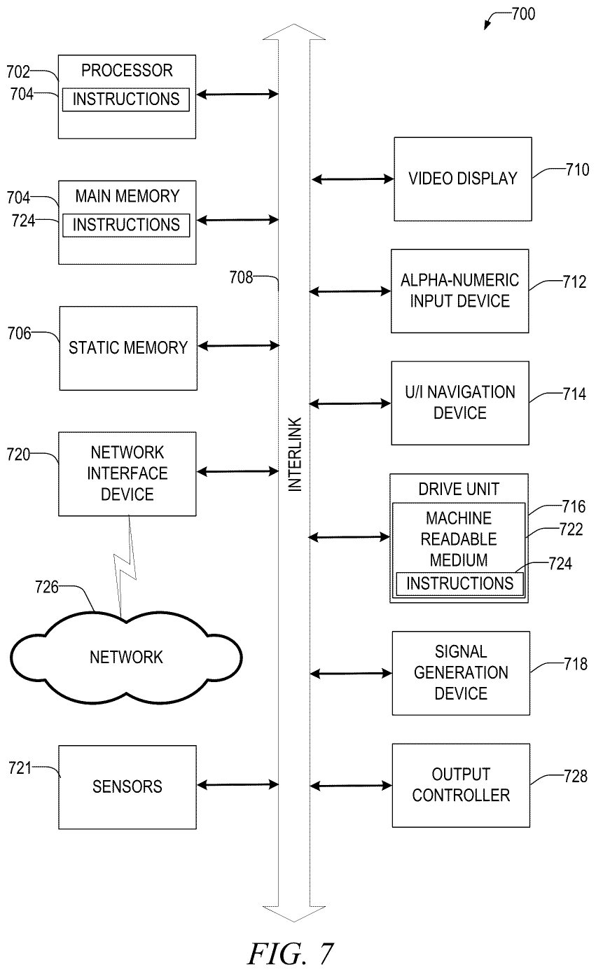

FIG. 7 illustrates a block diagram of an example machine 700 upon which any one or more of the techniques (e.g., methodologies) discussed herein may be performed. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be in the form of a server, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 700 may implement the models of FIGS. 1-4, the method of FIG. 5, and/or the components of FIG. 6.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 700 may include one or more hardware processors, such as processor 702. Processor 702 may be a central processing unit (CPU), a graphics processing unit (GPU), a hardware processor core, or any combination thereof. Machine 700 may include a main memory 704 and a static memory 706, some or all of which may communicate with each other via an interlink (e.g., bus) 708. Examples of main memory 704 may include Synchronous Dynamic Random-Access Memory (SDRAM), such as Double Data Rate memory, such as DDR4 or DDR5. Interlink 708 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 724 may further be transmitted or received over a communications network 726 using a transmission medium via the network interface device 720. The Machine 700 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

### Other Notes and Examples

Example 1 is a method for recovering a three-dimensional mesh model of an articulated object from a two-dimensional image, comprising: extracting features from the two-dimensional image by: generating a plurality of image patches from the two-dimensional image; generating a plurality of visual tokens and a classification (CLS) token by processing the plurality of image patches through a vision transformer encoder; predicting landmarks by: generating a plurality of landmark heatmaps using a convolutional decoder applied to the plurality of visual tokens; determining a plurality of initial landmark coordinates and confidence scores from the plurality of landmark heatmaps; refining the plurality of initial landmark coordinates using the CLS token and the plurality of initial landmark coordinates and confidence scores to create a plurality of refined landmark coordinates; estimating a three-dimensional pose of the articulated object by: performing landmark-based feature pooling using the plurality of refined landmark coordinates to generate a plurality of per-landmark features; processing the plurality of per-landmark features and the CLS token through a plurality of transformer decoder blocks; and generating a plurality of pose parameters for the articulated object; and generating a three-dimensional mesh of the articulated object using the pose parameters and a parametric model.

In Example 2, the subject matter of Example 1 includes, wherein generating the plurality of image patches comprises dividing the two-dimensional image into non-overlapping pixel patches.

In Example 3, the subject matter of Examples 1-2 includes, wherein the vision transformer encoder comprises multiple transformer encoder blocks, each block including a self-attention layer and a multi-layer perceptron layer.

In Example 4, the subject matter of Examples 1-3 includes, wherein determining the plurality of initial landmark coordinates comprises: finding a coordinate with a maximum likelihood in each landmark heatmap; and generating a confidence score for the coordinate with the maximum likelihood.

In Example 5, the subject matter of Examples 1~4 includes, wherein refining the initial landmark coordinates comprises: encoding information about the initial landmark coordinates using a first multi-layer perceptron layer; encoding information about the confidence scores using a second multi-layer perceptron layer; and processing the encoded information through a landmark refiner multi-layer perceptron layer.

In Example 6, the subject matter of Examples 1-5 includes, wherein performing landmark-based feature pooling comprises sampling features from the visual tokens at locations corresponding to the refined landmark coordinates.

In Example 7, the subject matter of Examples 1-6 includes, computing root orientation and translation using a Perspective-n-Point algorithm applied to the pose parameters.

Example 8 is a computing device for recovering a three-dimensional mesh model of an articulated object from a two-dimensional image, the computing device comprising: a hardware processor; a memory, the memory storing instructions, which when executed by the hardware processor cause the computing device to perform operations comprising: extracting features from the two-dimensional image by: generating a plurality of image patches from the two-dimensional image; generating a plurality of visual tokens and a classification (CLS) token by processing the plurality of image patches through a vision transformer encoder; predicting landmarks by: generating a plurality of landmark heatmaps using a convolutional decoder applied to the plurality of visual tokens; determining a plurality of initial landmark coordinates and confidence scores from the plurality of landmark heatmaps; refining the plurality of initial landmark coordinates using the CLS token and the plurality of initial landmark coordinates and confidence scores to create a plurality of refined landmark coordinates; estimating a three-dimensional pose of the articulated object by: performing landmark-based feature pooling using the plurality of refined landmark coordinates to generate a plurality of per-landmark features; processing the plurality of per-landmark features and the CLS token through a plurality of transformer decoder blocks; and generating a plurality of pose parameters for the articulated object; and generating a three-dimensional mesh of the articulated object using the pose parameters and a parametric model.

In Example 9, the subject matter of Example 8 includes, wherein the operations further comprise: wherein the operation of generating the plurality of image patches comprises dividing the two-dimensional image into non-overlapping pixel patches.

In Example 10, the subject matter of Examples 8-9 includes, wherein the operation of generating the plurality of visual tokens and the CLS token comprises: wherein the vision transformer encoder comprises multiple transformer encoder blocks, each block including a self-attention layer and a multi-layer perceptron layer.

In Example 11, the subject matter of Examples 8-10 includes, wherein the operation of determining the plurality of initial landmark coordinates comprises: finding a coordinate with a maximum likelihood in each landmark heatmap; and generating a confidence score for the coordinate with the maximum likelihood.

In Example 12, the subject matter of Examples 8-11 includes, wherein the operation of refining the initial landmark coordinates comprises: encoding information about the initial landmark coordinates using a first multi-layer perceptron layer; encoding information about the confidence scores using a second multi-layer perceptron layer; and processing the encoded information through a landmark refiner multi-layer perceptron layer.

In Example 13, the subject matter of Examples 8-12 includes, wherein the operation of performing landmark-based feature pooling comprises sampling features from the visual tokens at locations corresponding to the refined landmark coordinates.

In Example 14, the subject matter of Examples 8-13 includes, wherein the operations further comprise: computing root orientation and translation using a Perspective-n-Point algorithm applied to the pose parameters.

Example 15 is a non-transitory machine-readable medium, storing instructions for recovering a three-dimensional mesh model of an articulated object from a two-dimensional image, the instructions, which when executed, cause the machine to perform operations comprising: extracting features from the two-dimensional image by: generating a plurality of image patches from the two-dimensional image; generating a plurality of visual tokens and a classification (CLS) token by processing the plurality of image patches through a vision transformer encoder; predicting landmarks by: generating a plurality of landmark heatmaps using a convolutional decoder applied to the plurality of visual tokens; determining a plurality of initial landmark coordinates and confidence scores from the plurality of landmark heatmaps; refining the plurality of initial landmark coordinates using the CLS token and the plurality of initial landmark coordinates and confidence scores to create a plurality of refined landmark coordinates; estimating a three-dimensional pose of the articulated object by: performing landmark-based feature pooling using the plurality of refined landmark coordinates to generate a plurality of per-landmark features; processing the plurality of per-landmark features and the CLS token through a plurality of transformer decoder blocks; and generating a plurality of pose parameters for the articulated object; and generating a three-dimensional mesh of the articulated object using the pose parameters and a parametric model.

In Example 16, the subject matter of Example 15 includes, wherein the operations further comprise: wherein the operation of generating the plurality of image patches comprises dividing the two-dimensional image into non-overlapping pixel patches.

In Example 17, the subject matter of Examples 15-16 includes, wherein the operation of generating the plurality of visual tokens and the CLS token comprises: wherein the vision transformer encoder comprises multiple transformer encoder blocks, each block including a self-attention layer and a multi-layer perceptron layer.

In Example 18, the subject matter of Examples 15-17 includes, wherein the operation of determining the plurality of initial landmark coordinates comprises: finding a coordinate with a maximum likelihood in each landmark heatmap; and generating a confidence score for the coordinate with the maximum likelihood.

In Example 19, the subject matter of Examples 15-18 includes, wherein the operation of refining the initial landmark coordinates comprises: encoding information about the initial landmark coordinates using a first multi-layer perceptron layer; encoding information about the confidence scores using a second multi-layer perceptron layer; and processing the encoded information through a landmark refiner multi-layer perceptron layer.

In Example 20, the subject matter of Examples 15-19 includes, wherein the operation of performing landmark-based feature pooling comprises sampling features from the visual tokens at locations corresponding to the refined landmark coordinates.

In Example 21, the subject matter of Examples 15-20 includes, wherein the operations further comprise: computing root orientation and translation using a Perspective-n-Point algorithm applied to the pose parameters.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

What is claimed is:

1. A method for recovering a three-dimensional mesh model of an articulated object from a two-dimensional image, comprising:
extracting features from the two-dimensional image by:
generating a plurality of image patches from the two-dimensional image;
generating a plurality of visual tokens and a classification (CLS) token by processing
the plurality of image patches through a vision transformer encoder;
predicting landmarks by:
generating a plurality of landmark heatmaps using a convolutional decoder applied to the plurality of visual tokens;
determining a plurality of initial landmark coordinates and confidence scores from the plurality of landmark heatmaps;
refining the plurality of initial landmark coordinates using the CLS token and the plurality of initial landmark coordinates and confidence scores to create a plurality of refined landmark coordinates;
estimating a three-dimensional pose of the articulated object by:
performing landmark-based feature pooling using the plurality of refined landmark coordinates to generate a plurality of per-landmark features;
processing the plurality of per-landmark features and the CLS token through a plurality of transformer decoder blocks; and
generating a plurality of pose parameters for the articulated object; and
generating a three-dimensional mesh of the articulated object using the pose parameters and a parametric model.

2. The method of claim 1, wherein generating the plurality of image patches comprises dividing the two-dimensional image into non-overlapping pixel patches.

3. The method of claim 1, wherein the vision transformer encoder comprises multiple transformer encoder blocks, each block including a self-attention layer and a multi-layer perceptron layer.

4. The method of claim 1, wherein determining the plurality of initial landmark coordinates comprises:
finding a coordinate with a maximum likelihood in each landmark heatmap; and
generating a confidence score for the coordinate with the maximum likelihood.

5. The method of claim 1, wherein refining the initial landmark coordinates comprises:
encoding information about the initial landmark coordinates using a first multi-layer perceptron layer;
encoding information about the confidence scores using a second multi-layer perceptron layer; and
processing the encoded information through a landmark refiner multi-layer perceptron layer.

6. The method of claim 1, wherein performing landmark-based feature pooling comprises sampling features from the visual tokens at locations corresponding to the refined landmark coordinates.

7. The method of claim 1, further comprising:
computing root orientation and translation using a Perspective-n-Point algorithm applied to the pose parameters.

8. A computing device for recovering a three-dimensional mesh model of an articulated object from a two-dimensional image, the computing device comprising:
a hardware processor;
a memory, the memory storing instructions, which when executed by the hardware processor cause the computing device to perform operations comprising:
extracting features from the two-dimensional image by:
generating a plurality of image patches from the two-dimensional image;
generating a plurality of visual tokens and a classification (CLS) token by processing the plurality of image patches through a vision transformer encoder;
predicting landmarks by:
generating a plurality of landmark heatmaps using a convolutional decoder applied to the plurality of visual tokens;
determining a plurality of initial landmark coordinates and confidence scores from the plurality of landmark heatmaps;
refining the plurality of initial landmark coordinates using the CLS token and the plurality of initial landmark coordinates and confidence scores to create a plurality of refined landmark coordinates;
estimating a three-dimensional pose of the articulated object by:
performing landmark-based feature pooling using the plurality of refined landmark coordinates to generate a plurality of per-landmark features;
processing the plurality of per-landmark features and the CLS token through a plurality of transformer decoder blocks; and
generating a plurality of pose parameters for the articulated object; and
generating a three-dimensional mesh of the articulated object using the pose parameters and a parametric model.

9. The computing device of claim 8, wherein the operations further comprise:
wherein the operation of generating the plurality of image patches comprises dividing the two-dimensional image into non-overlapping pixel patches.

10. The computing device of claim 8, wherein the operation of generating the plurality of visual tokens and the CLS token comprises:
wherein the vision transformer encoder comprises multiple transformer encoder blocks, each block including a self-attention layer and a multi-layer perceptron layer.

11. The computing device of claim 8, wherein the operation of determining the plurality of initial landmark coordinates comprises:
finding a coordinate with a maximum likelihood in each landmark heatmap; and
generating a confidence score for the coordinate with the maximum likelihood.

12. The computing device of claim 8, wherein the operation of refining the initial landmark coordinates comprises:
encoding information about the initial landmark coordinates using a first multi-layer perceptron layer;
encoding information about the confidence scores using a second multi-layer perceptron layer; and
processing the encoded information through a landmark refiner multi-layer perceptron layer.

13. The computing device of claim 8, wherein the operation of performing landmark-based feature pooling comprises sampling features from the visual tokens at locations corresponding to the refined landmark coordinates.

14. The computing device of claim 8, wherein the operations further comprise:
computing root orientation and translation using a Perspective-n-Point algorithm applied to the pose parameters.

15. A non-transitory machine-readable medium, storing instructions for recovering a three-dimensional mesh model of an articulated object from a two-dimensional image, the instructions, which when executed, cause the machine to perform operations comprising:
extracting features from the two-dimensional image by:
generating a plurality of image patches from the two-dimensional image;
generating a plurality of visual tokens and a classification (CLS) token by processing the plurality of image patches through a vision transformer encoder;
predicting landmarks by:
generating a plurality of landmark heatmaps using a convolutional decoder applied to the plurality of visual tokens;
determining a plurality of initial landmark coordinates and confidence scores from the plurality of landmark heatmaps;
refining the plurality of initial landmark coordinates using the CLS token and the plurality of initial landmark coordinates and confidence scores to create a plurality of refined landmark coordinates;
estimating a three-dimensional pose of the articulated object by:
performing landmark-based feature pooling using the plurality of refined landmark coordinates to generate a plurality of per-landmark features;
processing the plurality of per-landmark features and the CLS token through a plurality of transformer decoder blocks; and
generating a plurality of pose parameters for the articulated object; and
generating a three-dimensional mesh of the articulated object using the pose parameters and a parametric model.

16. The non-transitory machine-readable medium of claim 15, wherein the operations further comprise:
wherein the operation of generating the plurality of image patches comprises dividing the two-dimensional image into non-overlapping pixel patches.

17. The non-transitory machine-readable medium of claim 15, wherein the operation of generating the plurality of visual tokens and the CLS token comprises:
wherein the vision transformer encoder comprises multiple transformer encoder blocks, each block including a self-attention layer and a multi-layer perceptron layer.

18. The non-transitory machine-readable medium of claim 15, wherein the operation of determining the plurality of initial landmark coordinates comprises:
finding a coordinate with a maximum likelihood in each landmark heatmap; and
generating a confidence score for the coordinate with the maximum likelihood.

19. The non-transitory machine-readable medium of claim 15, wherein the operation of refining the initial landmark coordinates comprises:
encoding information about the initial landmark coordinates using a first multi-layer perceptron layer;
encoding information about the confidence scores using a second multi-layer perceptron layer; and
processing the encoded information through a landmark refiner multi-layer perceptron layer.

20. The non-transitory machine-readable medium of claim 15, wherein the operation of performing landmark-based feature pooling comprises sampling features from the visual tokens at locations corresponding to the refined landmark coordinates.
